(19) United States
(12) Patent Application Publication
(10) Pub. No.: US 2025/0377999 A1
(43) Pub. Date: Dec. 11, 2025

(54) ON-SENSOR ANOMALY DETECTOR

(71) Applicant: STMicroelectronics International N.V., Geneva (CH)

(72) Inventors: Swapnil Sayan Saha, Mountain View, CA (US); Mahesh Chowdhary, San Jose, CA (US)

(21) Appl. No.: 18/738,762

(22) Filed: Jun. 10, 2024

(51) Int. Cl. G06F 11/34; G06F 11/30; G06F 11/32

(52) U.S. Cl. CPC G06F 11/3409; G06F 11/324; G06F 11/3089

(57) ABSTRACT

According to an embodiment, a method to detect anomalies in a device is proposed. The method includes accumulating q samples of sensor data within a rolling window, each of the q samples of sensor data corresponding to a temporal characteristic of the device during its normal operation; calculating a rolling variance for the q samples of sensor data; extracting a first principal component of the q samples of sensor data; calculating a minimum distance and a mean distance to cluster centroids based on a previously collected first principal component during a training phase; detecting an anomaly within the device based on the rolling variance, the minimum distance to the cluster centroids, and the mean distance to the cluster centroids; and signaling an alert signal in response to detecting the anomaly.

### TECHNICAL FIELD

The present disclosure generally relates to anomaly detection and, in particular embodiments, to an on-sensor anomaly detector.

### BACKGROUND

Generally, anomaly detection is the process of identifying unexpected deviations from a device’s normal behavior, which can serve as an early indication of potential problems or malfunctions. Traditional anomaly detection systems exist to monitor these variations, but they are hindered by latency and response times, making them suboptimal for real-time applications. For instance, reliance on cloud-based analytics could be impractical due to time delays and significant bandwidth consumption in vehicular technologies requiring immediate crash detection.

Further, industrial environments that utilize robots and sensor nodes also employ anomaly detection. However, the devices' inherent limitations in memory, processing power, and computational capacity often challenge these implementations. Thus, any proposed anomaly detection mechanism should be capable of operating within these resource constraints while maintaining effective performance.

### SUMMARY

Technical advantages are generally achieved by embodiments of this disclosure, which describe an on-sensor anomaly detector.

A first aspect relates to a system for detecting anomalies. The system comprising a device and an internal measurement unit (IMU) circuit coupled to the device. The IMU circuit is configured to accumulate q samples of sensor data within a rolling window, each of the q samples of sensor data corresponding to a temporal characteristic of the device during its normal operation, calculate a rolling variance for the q samples of sensor data, extract a first principal component of the q samples of sensor data, calculate a minimum distance and a mean distance to cluster centroids based on a previously collected first principal component during a training phase, detect an anomaly within the device based on the rolling variance, the minimum distance to the cluster centroids, and the mean distance to the cluster centroids, and signal an alert signal in response to detecting the anomaly.

A second aspect relates to an internal measurement unit (IMU) circuit configured to detect anomalies in a device. The IMU circuit comprises a sensor configured to collect measurements from the device, a non-transitory memory storage comprising instructions, and an integrated signal processing unit (ISPU) coupled to the non-transitory memory storage. The instructions, when executed by the ISPU, cause the IMU circuit to accumulate, by the sensor, q samples of sensor data within a rolling window, each of the q samples of sensor data corresponding to a temporal characteristic of the device during its normal operation, calculate a rolling variance for the q samples of sensor data, extract a first principal component of the q samples of sensor data, calculate a minimum distance and a mean distance to cluster centroids based on a previously collected first principal component during a training phase, detect an anomaly within the device based on the rolling variance, the minimum distance to the cluster centroids, and the mean distance to the cluster centroids, and signal an alert signal in response to detecting the anomaly.

A third aspect relates to a method to detect anomalies in a device. The method comprising accumulating q samples of sensor data within a rolling window, each of the q samples of sensor data corresponding to a temporal characteristic of the device during its normal operation; calculating a rolling variance for the q samples of sensor data; extracting a first principal component of the q samples of sensor data; calculating a minimum distance and a mean distance to cluster centroids based on a previously collected first principal component during a training phase; detecting an anomaly within the device based on the rolling variance, the minimum distance to the cluster centroids, and the mean distance to the cluster centroids; and signaling an alert signal in response to detecting the anomaly.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a flow chart of an embodiment method for training an on-sensor anomaly detection algorithm;

FIG. 2 is a flow chart of an embodiment method for operating the on-sensor algorithm used for anomaly detection;

FIG. 3 is a flow chart of an embodiment method for an anomaly detection calculation; and

FIG. 4 is a block diagram of a system.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of detecting anomalies using a gyroscope and an accelerometer, it should also be appreciated that these inventive aspects may also apply to other systems using other types of sensors. For example, the disclosed embodiments may be run or executed on sensors with high sampling rates and bandwidth, rendering the disclosed material advantageous for detecting vibrational anomalies. In particular, aspects of this disclosure may similarly apply to industrial applications, such as automotive, aerospace, and consumer applications.

Aspects of the disclosure may be adapted to scenarios by accounting for the differences in behavioral parameters of machines operating in distinct environments. An example of this adaptability is the system's ability to alter or personalize these parameters automatically without user intervention. This feature ensures that the system maintains effective functionality and performance regardless of operating conditions or specific machine nuances.

For example, consider a household fan system. Anomaly detection aims to identify aberrant behaviors of the fan (e.g., unusual vibrations) without knowing what constitutes an anomaly. This is done by monitoring parameters that define the system's regular operation and flagging any outputs that deviate beyond predetermined thresholds. This method can address issues before reaching a critical stage, ensuring the system's proper functioning and longevity.

Conventional anomaly detection solutions, especially cloud-based ones, present several drawbacks. These solutions are typically resource-intensive and require substantial communication bandwidth, which poses challenges in time-sensitive applications. They cannot offer the real-time response necessary for critical systems such as autonomous vehicles.

An advantage of the proposed solution implemented in a sensor is enhanced power efficiency. This efficiency stems from the fact that it obviates the necessity to, for example, transmit raw sensor data to a microcontroller via the serial interface. By processing data directly on the sensor, the proposed embodiments conserve energy that would otherwise be expended during data transfer, thereby optimizing power consumption.

Transmitting large volumes of sensor data to the cloud for analysis also results in significant bandwidth consumption, which can be prohibitive in cost. In addition, devices that are limited in their computational capabilities, like industrial sensor nodes, need help to support the complexity of traditional anomaly detection algorithms. While simpler on-sensor variance-based algorithms can be available, the basic methods in the current solutions could be more effective when deployed as a standalone unit.

A significant attribute of the embodiments disclosed herein is adaptability—considering the diversity in fan behaviors based on their design and operational context. For example, in the case of a fan, it may exhibit unique parameters that must be understood for optimal performance. Hence, the embodiments disclosed are adaptable to self-learning and can automatically tune to varying parameters of different fans. This self-adjustment capability ensures effectiveness across a range of devices with distinct behavioral patterns without requiring manual recalibration for each specific type.

In embodiments, two stages are proposed for anomaly detection in machinery, using a fan as an example. In the first stage, the system is trained to recognize the fan's normal operating behavior. This training is conducted by collecting data from, for example, an accelerometer and gyroscope attached to the fan across various normal operating modes. The information gathered is then processed to extract principal components and normal rolling variance stored within the system's file system. During the second stage, known as inference, the system again collects data from, for example, the accelerometer and gyroscope for a few seconds. It computes the rolling variance of this data and extracts principal components in real time. The system then compares these real-time principal components and rolling variances with those stored during training to determine how closely they match. Following this comparison, the data is processed by an anomaly detection logic, which evaluates whether the operation is normal or constitutes an anomaly based on distance metrics and rolling variance thresholds. This detection mechanism flags any deviations from the established norm of operation, alerting users or systems to potential issues.

In embodiments, an anomaly detection solution with local, on-sensor anomaly detection algorithms is proposed without using cloud-based solutions. The proposed algorithms deliver a potent, versatile, real-time anomaly detection capability, maintaining resource efficiency suitable for diverse applications.

The impetus for developing on-device anomaly detection algorithms stems from their numerous benefits across varied applications. These on-sensor algorithms can process data and identify anomalies in situ, facilitating instantaneous responses critical for cases where any delay could be detrimental. Such immediacy can be vital in sectors involving autonomous vehicles, medical devices, and industrial control systems, where time is of the essence.

Further, by conducting analysis locally, these algorithms substantially curtail the need for massive data transfers to the cloud, thus alleviating the burden on bandwidth and reducing communication costs. This localized analysis also contributes to creating markedly low power consumption solutions.

Looking closely at practical applications, one can see the value in industries such as predictive maintenance. For example, sensors attached to industrial equipment can be pivotal in recognizing irregularities that may precede equipment failure, prompting preemptive maintenance and averting expensive malfunctions.

Likewise, wearable technology with such algorithms in personalized healthcare can continuously assess an individual's vital signs. By pinpointing any deviations from normal patterns, these devices offer a chance for early medical intervention and treatment, personalizing patient care and enhancing health outcomes. These and additional details are further detailed below.

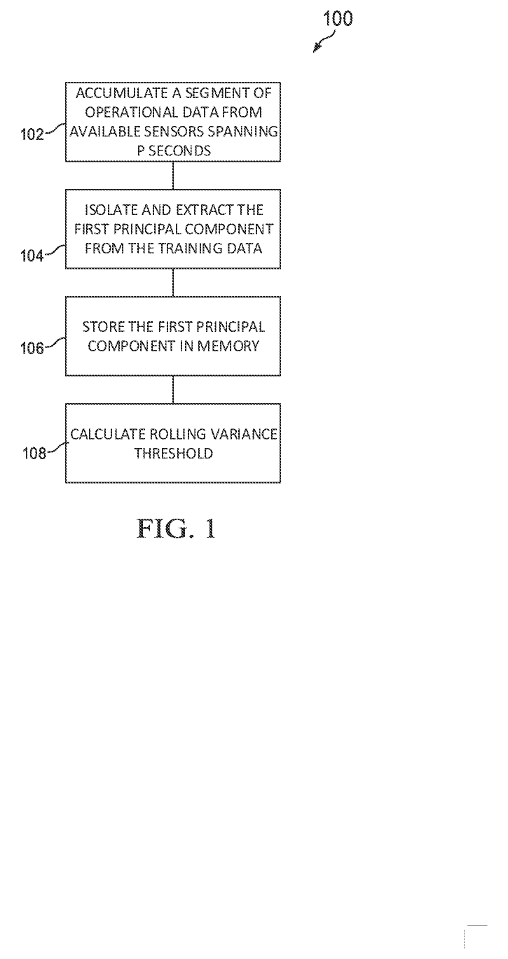

FIG. 1 illustrates a flow chart of an embodiment method 100 for training an on-sensor anomaly detection algorithm. In embodiments, the on-sensor algorithm is exclusively trained using data from the machinery’s standard operating procedures. In embodiments, the algorithm is trained daily based on the normal operation modes that the system encounters. It is noted that all steps outlined in the flow chart of method 100 are not necessarily required and can be optional. Further, changes to the arrangement of the steps, removal of one or more steps and path connections, and addition of steps and path connections are similarly contemplated. In embodiments, method 100 occurs within the ISPU on the sensor, in-situ.

At step 102, the training mode accumulates a segment of operational data from available sensors spanning p seconds. In embodiments, the collected data is temporarily stored within the Integrated Signal Processing Unit (ISPU) signal buffer of, for example, an Inertial Measurement Unit (IMU).

The ISPU signal buffer is configured as a provisional holding area for real-time data harnessed from the system during operation. The ISPU is configured to run an anomaly detection logic in-situ. In embodiments, the operational data correspond to data collected by an accelerometer, a gyroscope, or a combination thereof. This method can also be applied to similar sensors with different computing capabilities.

At step 104, once the ISPU signal buffer has secured the requisite allotment of data, the algorithm applies a mathematical procedure known as principal component analysis (PCA) to the collected data to isolate and extract the first principal component from the buffered data. Advantageously, the initial principal component captures the maximum variance in the dataset, reflecting the core pattern of the machinery's normal functioning. By focusing on this component, the algorithm can more effectively identify deviations that may signify operational anomalies.

Principal component analysis is an automated methodological approach to distill a paramount subset of characteristics from noisy and multidimensional signals. Its primary objective is to preserve the most information and variance from noisy and high-dimensional signal data.

In machinery operations, standard functioning typically manifests as a noticeable peak in the principal component analysis data chart (i.e., PCA manifold histogram), often resembling a skewed Gaussian distribution, coupled with the diminished variance within the principal component analysis manifold histogram.

In contrast, operations considered anomalous are characterized by their considerable variance and tend to exhibit a pattern more akin to a uniform distribution in the principal component analysis manifold histogram. However, this is not an absolute rule, and exceptions may occur.

In embodiments, an algorithm rooted in principal component analysis can be incorporated directly into the sensor to capitalize on this analytical technique. The algorithm conducts a series of tasks, such as normalizing raw signals, constructing the covariance matrix, extracting eigenvectors and eigenvalues, sequencing the eigenvectors in order of significance, and deploying the transformation on the raw data to extract the first principal component.

In embodiments, a corresponding first principal component is extracted for each normal operating mode. For example, if the fan has six normal operating modes (low to high rotation), each setting has a corresponding first principal component.

At step 106, after extracting one or more first principal components, the data is stored for subsequent analysis and reference. In embodiments, the distilled first principal component transformed data is cataloged and conserved within a designated filesystem. The filesystem is structured for optimal organization and data retrieval, enabling prompt access for further learning tasks or comparative analysis during active anomaly detection. By storing this valuable information, the algorithm shores up its foundational knowledge base, bolstering its capacity to discern between typical behavior and potential anomalies in the system’s operation.

At step 108, a rolling variance threshold is determined based on the data collected at step 102. In embodiments, an average rolling variance is calculated from the data collected at step 102. For the first operating mode of the system hosting the sensor, the rolling variance threshold is set to a temporary threshold value that is N % greater than the calculated average rolling variance—N being a percentage value between 1 and 99. In embodiments, N equals 10. In embodiments, N is an adjustable value. The rolling variance threshold is stored in memory.

In embodiments where the system has multiple operating modes, the average rolling variance is calculated for the data collected at the second operating mode. If the rolling variance threshold for the first operating mode is less than the calculated average rolling variance of the second operating mode, the rolling variance threshold is set to a threshold value that is N % greater than the second calculated average rolling variance. This process is repeated for each operating mode. The rolling variance threshold determined at the last operating mode is stored in memory.

In embodiments, a different rolling variance threshold is determined for each operating mode of the system. The rolling variance threshold for each operating mode is stored in memory.

In embodiments, the training phase is performed during production or manufacturing. In embodiments, the training phase may be applied after the deployment of the machinery to be monitored according to a schedule. For example, an engineer may want to update the first principal component associated with the machinery in the specific environment the machine has been deployed. Accordingly, the engineer may run a training phase before the normal operation of the machinery to extract one or more principal components during the training phase for the specific environment. The engineer can run the training phase for various operating conditions. For example, the engineer can run the training phase when a vehicle is running on a road surface, a track surface, an off-road surface, and in various weather conditions.

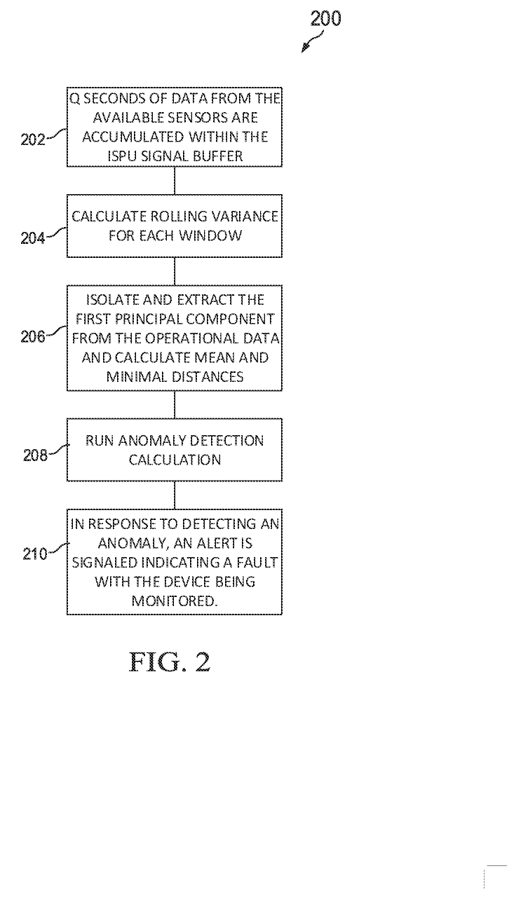

FIG. 2 illustrates a flow chart of an embodiment method 200 for operating the on-sensor algorithm used for anomaly detection. Method 200 relates to the inference mode of the system based on, for example, the training mode outlined in method 100. It is noted that all steps outlined in the flow chart of method 200 are not necessarily required and can be optional. Further, changes to the arrangement of the steps, removal of one or more steps and path connections, and addition of steps and path connections are similarly contemplated.

During normal operation (i.e., inference phase), at step 202, q seconds of data from the available sensors are accumulated within the ISPU signal buffer (rolling time windows). In embodiments, the operational data correspond to data collected by an accelerometer, a gyroscope, or a combination thereof.

In embodiments, q is between 0.5 and 3 seconds, and in one embodiment, q is 2 seconds. In embodiments, p is between 3 and 10 seconds, and in one embodiment, p is 6 seconds.

At step 204, the raw rolling variance is actively calculated and monitored for the accumulated signal within the ISPU signal buffer. In embodiments, the rolling variance calculation is performed automatically. The monitoring function detects abrupt temporal changes within the incoming signal stream by comparing the rolling variance with a variance threshold and detecting an anomaly in response to the calculated rolling variance falling outside the threshold. A rolling variance coefficient alpha, possibly distinct for various sensors (e.g., accelerometer and gyroscope data), is applied as a low-pass filter to adjust the responsiveness to signal fluctuations.

In embodiments, the gyroscope rolling variance is normalized for each axis by the angular rate. In embodiments, the rolling variance calculation is performed continuously, sample by sample, during the inference phase while populating the ISPU signal buffer at step 202.

Based on the different operating conditions and the application, the rolling variance measurement usefulness in differentiating temporal changes between the normal and anomalous operating modes may be limited to certain operational windows. Accordingly, outside these operational windows, the rolling variance measurement can become vulnerable to interference from mechanical system artifacts resembling anomalous behavior.

Due to this susceptibility, reliance on rolling variance alone is typically deemed insufficient for the robust detection of anomalies. Despite these limitations, it should be noted that the rolling variance-based calculator consistently successfully identifies the precise change points where there is a switch between different operating modes. This ability to pinpoint change points highlights its effectiveness in certain aspects of operational monitoring, even though, in some embodiments, it would be advantageous to rely on something other than this parameter for comprehensive anomaly detection across all duty cycles.

Returning to the example of the fan, when the fan begins to vibrate unexpectedly during normal operation, the system can detect this aberrant behavior through the rolling variance calculator, where a notable increase in the rolling variance of the data would be observed. This variance data serves as additional information that, when used in conjunction with principal component analysis, allows for a more informed decision-making process in determining the presence of an anomaly. For example, the rolling variance measurement for the example of the fan can differentiate temporal changes between the normal and anomalous operating modes at duty cycles below 60 %.

In embodiments, the rolling variance coefficient for a first sensor (e.g., accelerometer) is between 0 and 1. In an embodiment, the rolling variance coefficient for the first sensor is set to 0.05.

In embodiments, the rolling variance coefficient for a second sensor (e.g., gyroscope) is between 0 and 1. In an embodiment, the rolling variance coefficient for the second sensor is set to 0.05.

In embodiments, the sampling rate (i.e., the output date rate (ODR) of the IMU) is between 26 and 6666 Hz. In embodiments, the sampling rate is between 2.5 kHz and 40 KHz. In embodiments, the sampling rate is set to 26 Hz.

In embodiments, the number of samples stored during the training phase is between 3 and 10 multipliers of the sampling rate. In embodiments, the number of samples stored during the training phase is set to six multipliers (i.e. 6 seconds) of the sampling rate.

In embodiments, the window size during the inference phase is between 0.5 and 3 multipliers of the sampling rate. In embodiments, the window size during the inference phase is set to two multipliers (i.e. 2 seconds) of the sampling rate.

At step 206, the first principal components are extracted from the q seconds of data accumulated within the ISPU signal buffer, and the first principal components extracted during the training phase are retrieved from memory. These first principal components (from the training and inference) are used to perform a distance calculator function to ascertain the minimum and mean distances to cluster centroids. The distance calculator function calculates the mean and minimum distances between cluster centroids from training templates and an inference template.

The rationale is that signals from a regular operational mode are typically closer to stored templates, as reflected by lower mean and minimum cluster distances, than signals indicative of an anomalous mode.

In embodiments, a weighted amalgamation of three distance measures—Euclidean, Minkowski (of fourth order), and Chebyshev—is used to differentiate between normal and abnormal signals precisely. Accordingly, each distance measurement (Euclidean, Minkowski (of fourth order), and Chebyshev) calculates a distance value. The distance value from each measurement is then used to generate a single distance value based on a weighted factor of the respective distance measurement.

In embodiments, the weight factor for the Euclidian distance is between 0 and 1. In embodiments, the weight factor for the Euclidian distance is set to 0.1946.

In embodiments, the weight factor for the Cheyshev distance is between 0 and 1. In embodiments, the weight factor for the Cheyshev distance is set to 1.0.

In embodiments, the weight factor for the Minkowski distance is between 0 and 1. In embodiments, the weight factor for the Minkowski distance is set to 0.5749.

In embodiments, the weight factor for the Euclidian, Cheyshev, and Minkowski distances are equal.

The Euclidean and Minkowski distances typically yield a greater separation between cluster centroids than the Chebyshev distance. This separation measures how distinct the clusters are in the data space; greater separation implies that clusters are more easily distinguishable. However, with increased centroid separation using Euclidean and Minkowski metrics, there is also an accompanying increase in noise within the data. Noise can introduce variability that complicates the interpretation of the cluster structures. Conversely, the Chebyshev distance, known for its emphasis on the maximum difference among dimensions, tends to present less noise in the clustering process. While this can lead to cleaner and more stable cluster formation, it does so at the expense of reduced separation between the centroids of clusters. The reduced separation can make it more challenging to differentiate between clusters, calling for a careful consideration of the trade-off between noise levels and centroid separation when choosing the most appropriate distance metric for a given clustering task.

Accordingly, selecting a weight factor for each distance measurement can differentiate normal signals from anomalous ones. The discriminative power of the analysis can be enhanced by assigning appropriate weights to each of these distance measurements, which capture various geometric and mathematical relationships between data points. The Euclidean distance offers a standard measure of straight-line distance, the Minkowski distance with a fourth-order parameter emphasizes greater disparities, and the Chebyshev distance focuses on the maximum absolute difference between coordinates. When combined, these different perspectives provide a nuanced approach to signal classification, allowing the identification of anomalies in the data by how they diverge from expected norms within a multidimensional space.

When analyzing the efficacy of various distance measurements for clustering, it has been determined that the Cosine, Canberra, and Mahalanobis distances are generally not viable options under certain conditions. For example, despite being useful for measuring orientation agreement between vectors, the Cosine distance fails to effectively separate centroids after a Principal Component Analysis (PCA), leading to clusters that are not distinctly partitioned. The Canberra distance also experiences difficulty, with a notable issue being its tendency to confuse normal and anomalous signals; this confusion may result from its sensitivity to small changes when values are near zero. Lastly, the Mahalanobis distance encounters a technical complication known as covariance singularity; this situation arises when the inverse covariance matrix, which is central to the distance calculation, cannot be computed due to a lack of variability in the data. Additionally, the Mahalanobis distance often needs a sufficient separation between PCA centroids, making it challenging to differentiate between clusters. These limitations underscore the importance of selecting appropriate distance metrics tailored to the specific nuances of the dataset and the intended clustering objectives.

It should be noted that the Cosine, Canberra, and Mahalanobis distances may be implemented in some embodiments based on specific data associated with the application. Accordingly, although the embodiments disclosed herein have been implemented using a combination weighted factor using Euclidean, Minkowski (of fourth order), and Chebyshev, the use of other distances such as the Cosine, Canberra, and Mahalanobis distances are not excluded. For example, in some embodiments, one or more other types of distance calculations can be combined or used instead of the Euclidean, Minkowski (of fourth order), and Chebyshev distances.

Mean and minimum distances are advantageous for accurate inference. The minimum distance corrects any time alignment errors caused by comparing a q-second window against a p-second template through a sliding window approach; meanwhile, the mean distance offers an overarching perspective of the cluster manifold space.

Utilizing the mean and minimum cluster distances is advantageous within a sliding window comparison and time-series data. When evaluating the characteristics of principal component datasets over time, a window of q seconds during the inference phase is juxtaposed against a window of p seconds from the training phase. Using the minimum cluster distance mitigates potential errors related to the alignment of timestamps. By accounting for the lowest data points, or minima, within each window, one can correct for discrepancies that arise from misaligned time intervals between windows. On the other hand, calculating the mean cluster distance provides a complementary perspective by summarizing the central tendency of the data over a larger span. This broader overview captures the overall state of the dataset, effectively representing the behavior within the multidimensional space formed by clusters of data points (i.e., the cluster manifold space). These statistical metrics, in tandem, allow for a more comprehensive and robust inference, ensuring that local variations and global patterns are considered.

At step 208, an anomaly detection calculation merges various metrics—signal rolling variance, mean cluster distance, and minimum cluster distance—to ascertain the final inference output.

At step 210, in response to detecting an anomaly, an alert is signaled, indicating a fault with the device being monitored.

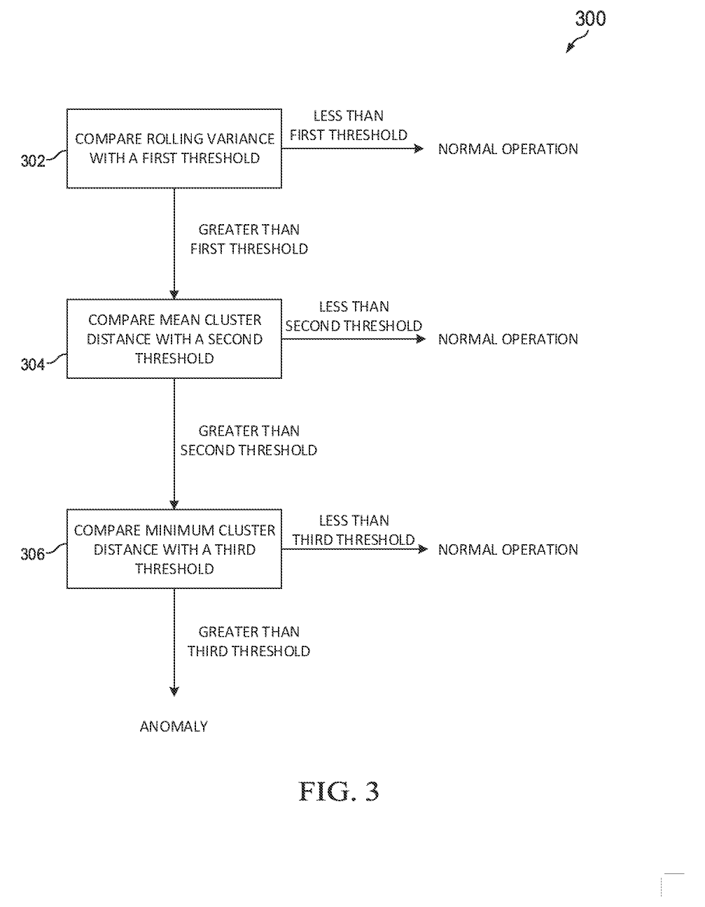

FIG. 3 illustrates a flow chart of an embodiment method 300 for an anomaly detection calculation, which may be implemented at step 208 of method 200. It is noted that all steps outlined in the flow chart of method 300 are not necessarily required and can be optional. Further, changes to the arrangement of the steps, removal of one or more steps and path connections, and addition of steps and path connections are similarly contemplated.

At step 302, the rolling variance of the sensor is compared to a first threshold. Operations are considered normal if the rolling variance does not exceed the first threshold (e.g., calculated during training or set by the user). In embodiments, the first threshold is determined at step 108 of method 100.

In embodiments, the rolling variance for each sensor (e.g., accelerometer, gyroscope, temperature sensor, etc.) is compared to a corresponding threshold for the particular sensor (e.g., calculated during training or set by the user). In response to the respective rolling variance for a sensor being below its respective threshold, the operation of the device is considered normal.

In embodiments, a threshold of rolling variance on the raw sensor data for the first sensor (e.g., accelerometer) beyond which the data is possibly anomalous is between 0 and 1. In embodiments, a threshold of rolling variance on the raw sensor data for the first sensor (e.g., accelerometer) beyond which the data is possibly anomalous is set to 0.002.

In embodiments, a threshold of rolling variance on the raw sensor data for the second sensor (e.g., gyroscope) beyond which the data is possibly anomalous is between 0 and 1. In embodiments, a threshold of rolling variance on the raw sensor data for the second sensor (e.g., gyroscope) beyond which the data is possibly anomalous is set to 0.002.

At step 304, if the rolling variance exceeds the first threshold, the mean cluster distance is compared against a second threshold. The operation is considered normal if the mean cluster distance remains below the second threshold.

In embodiments, the comparison can be extended across n number of rolling windows to account for fluctuating datasets. In such embodiments, the operation is considered anomalous when a subset or all comparisons across the n number of rolling windows exceed the second threshold.

The mean distance between the principal component analysis cluster centroids above which an anomaly should be considered depends on the application. In embodiments, the mean distance between the principal component analysis cluster centroids above which an anomaly should be considered is greater than 0.5. In embodiments, the mean distance between the principal component analysis cluster centroids above which an anomaly should be considered is set to 5.5.

At step 306, if the mean cluster distance exceeds the second threshold, the minimum cluster distance is compared against a third threshold. if none of the preceding thresholds serve to classify normal operation and the minimum cluster distance exceeds a third threshold, an anomaly is detected.

In embodiments, the number of past distance calculations to consider when checking for an anomaly (i.e., consistency check) is between 1 and 5. In embodiments, the number of past distance calculations to consider when checking for an anomaly (i.e., consistency check) is set to three.

The minimum distance between the principal component analysis cluster centroids above which an anomaly should be considered can depend on the application. In embodiments, the minimum distance between the principal component analysis cluster centroids above which an anomaly should be considered is greater than 0.5. In embodiments, the minimum distance between the principal component analysis cluster centroids above which an anomaly should be considered is set to 1.5.

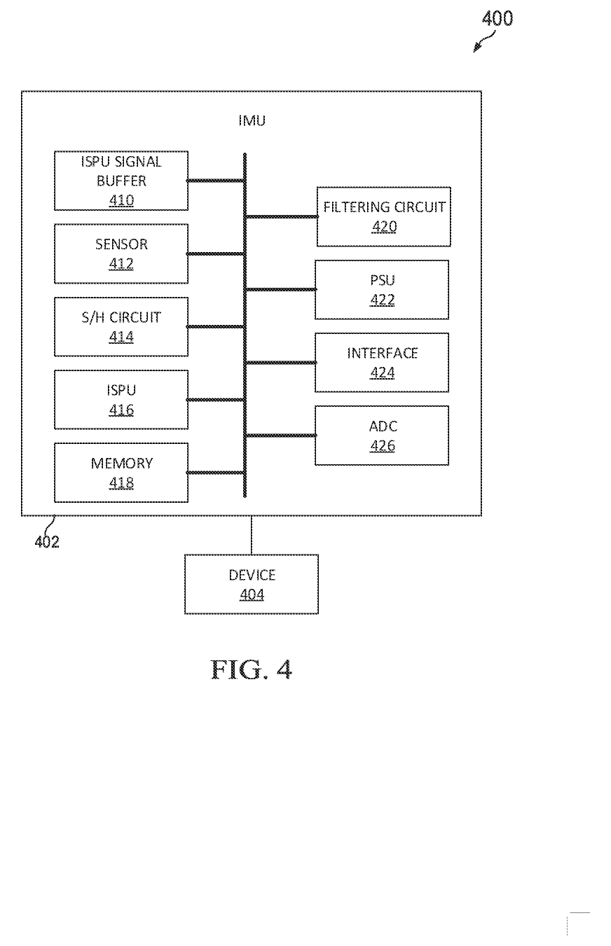

FIG. 4 illustrates a block diagram of a system 400 incorporating the embodiments disclosed herein. System 400 includes an internal measurement unit (IMU) circuit 402 and device 404, which may (or may not) be arranged as shown.

In embodiments, IMU circuit 402 includes an (ISPU) signal buffer 410, a sensor 412, a sample and hold (S/H) circuit 414, an ISPU 416, a memory 418, a filtering circuit 420, a power supply unit (PSU) 422, an interface 424, an analog-to-digital converter (ADC) 426, which may (or may not) be arranged as shown. In embodiments, the ISPU signal buffer 410 is part of the ISPU 416.

Although one of each component is shown in FIG. 4, the number of components is not limiting, and greater numbers are similarly contemplated in other embodiments. System 400 may include additional components not depicted, such as long-term storage (e.g., non-volatile memory, etc.), power management circuitry, security and encryption modules (e.g., trusted platform modules (TPM), etc.), or the like. System 400 may be an electronic device, such as a smartphone, a tablet, a laptop, a smartwatch, a vehicle, or any system or sub-system capable of hosting the sensor 412. System 400 could be embedded within electronic devices, industrial machinery, or wearable technology, providing vital feedback for maintenance, user experience optimization, or safety purposes.

In embodiments, each component can communicate with any other component internally within or external to the system 400. For example, each component can communicate using the I²C (Inter-Integrated Circuit), alternatively known as I2C or IIC, communication protocol, the I3C (Improved Inter Integrated Circuit) communication protocol, the serial peripheral interface (SPI) specification, or the like.

In embodiments, ISPU signal buffer 410 serves as an intermediary storage area for the IMU circuit 402 that temporarily holds the raw data signals from the sensors 412 before they are processed by the ISPU 416. The ISPU signal buffer 410 can synchronize data streams from the multitude of sensors within the sensor 412, ensuring that data are not lost or misaligned when the ISPU experiences momentary high loads or concurrent tasks that might otherwise lead to a bottleneck. ISPU signal buffer 410 is typically optimized for low latency and high data throughput. In embodiments, the ISPU signal buffer 410 is part of the ISPU 416.

ISPU signal buffer 410 may be implemented using volatile memory like SRAM or FIFO (first-in, first-out) registers along with control logic that manages data integrity and flow control to match the processing cadence of the ISPU 416.

In embodiments, sensor 412 may include one or more sensing elements, each optimized for detecting parameters such as temperature, pressure, humidity, voltage, current, vibrations, and motion. In embodiments, sensor 412 is compact and energy-efficient, capable of real-time data acquisition and processing. In embodiments, sensor 412 includes a microelectromechanical system (MEMS) for precise movement detection, a thermocouple or resistance temperature detector (RTD) for thermal monitoring, a piezoelectric or capacitive element for pressure changes, a hygrometer for moisture levels, or a combination thereof.

In embodiments, sensor 412 may include an embedded microcontroller and memory that can perform one or all of the operations related to ISPU 416 and memory 418. Advanced signal processing capabilities could enable the sensor to perform onboard data analysis, error correction, and wireless communication to transmit the measured parameters to a central processor (e.g., ISPU 416) for further evaluation and action.

In embodiments, S/H circuit 414 is configured to accurately capture the analog signals from sensor 412, such as the voltage outputs from accelerometers or gyroscopes, at a specific point in time. The S/H circuit 414 works by momentarily sampling the sensor's analog output and then holding this value constant long enough for the ADC 426 to accurately convert it into a digital form that can be processed by the ISPU 416. A precision timing signal typically controls the sample phase, ensuring synchrony with the system clock. During the hold phase, the S/H circuit 414 maintains the sampled voltage with minimal decay, preserving the signal's integrity against the sampling requirements of the ADC 426. The S/H circuit 414 reduces noise and ensures that dynamic sensor data are accurately digitized, thus enabling the IMU circuit 402 to deliver precise measurements of acceleration, rotation rate, and other data.

ISPU 416 may be any component or collection of components adapted to perform computations or other processing-related tasks. In embodiments, ISPU 416 is an application processor or a microcontroller. ISPU 416 or certain cores of ISPU 416 are configured to continuously sample and monitor device 404 for anomalies. In embodiments, the ISPU 416 is configured to process, filter, condition, and convert raw sensor data into usable information.

In embodiments, ISPU 416 receives meaningful data from sensor 412, such as shock intensity, duration, and type of surface causing the shock, which can be further processed by ISPU 416 to detect, for example, a car crash, a fall detection event, a device failure, a device anomaly, or used for warranty and insurance purposes.

Memory 418 may be any component or collection of components adapted to store programming or instructions for execution by ISPU 416. In an embodiment, memory 418 includes a non-transitory computer-readable medium. In embodiments, memory 418 is configured to store the instructions to perform methods 100 and 200 and store the first principal component extracted during the training phase.

Filtering circuit 420 is configured to ensure that the output data from sensor 412 are free from noise and unwanted frequencies that could distort the measurements. Filtering circuit 420 might consist of a combination of low-pass, high-pass, and notch filters designed to attenuate or eliminate specific frequency ranges that are not characteristic of the true motion being measured, such as high-frequency vibrations or the effects of electrical interference. Low-pass filters are particularly important as they allow signals below a designated cutoff frequency (representative of actual movement) to pass through while attenuating the higher frequencies that may include noise and transient disruptions.

Power supply unit 422 may be any component or collection of components that provides power to one or more components within the system 400. It may include various power management circuitry, charge storage components (e.g., battery), and the like.

Interface 424 may be any component or collection of components that allow ISPU 416 to communicate with other devices/components or a user. For example, interface 424 may be adapted to allow a user or sensor 412 to interact/communicate with the system 400. Further, interface 424 may include circuitry that allows system 400 to communicate signals to notify emergency contacts or trigger an automatic emergency response based on the type of surface the device has fallen on.

ADC 426 is configured to convert the continuous analog signals generated by sensor 412 into discrete digital representations that can be processed by digital electronics. This conversion process involves sampling the analog signal at regular intervals determined by the ADC's sampling rate and quantifying the amplitude at each sample point to a certain resolution, typically measured in bits. The ADC's resolution determines how finely it can distinguish between different signal levels, with higher resolution providing greater accuracy but often requiring more power and longer conversion times.

In embodiments, IMU circuit 402 is configured to monitor the device 404 for anomalies using sensor 412 to, for example, continuously measure and track the device's motion and orientation. Aided by the proposed solution in embodiments disclosed herein, IMU circuit 402 can detect deviations from expected movement patterns, vibrational profiles, or orientation norms that indicate potential malfunctions or structural issues during the inference phase.

The ISPU 416 can be programmed with instructions to perform methods 100 and 200 to store baseline parameters (i.e., the first principal components) that define the standard operational behavior of device 404 during the training phase in memory 418. When the IMU circuit 402 captures data that falls outside of these predetermined thresholds, it triggers an alert or feeds information into a diagnostic system indicating an anomaly.

The real-time monitoring capability with minimal computing resources is advantageous for predictive maintenance in machinery, ensuring operational safety in vehicles, and securing the integrity of structures prone to stress and wear. It enables timely intervention before minor issues escalate into significant failures or catastrophes.

Device 404 may be heavy machinery such as turbines, pumps, or conveyor belts in the industrial sector. IMU circuit 402 can be configured to measure and monitor vibrations and abnormal movements that may signal wear and tear, the need for predictive maintenance, or immediate mechanical malfunctions. Real-time detection of such anomalies enables operators to address issues, minimizing downtime and extending equipment longevity promptly.

The aerospace industry can also benefit from anomaly detection to ensure the safe and accurate navigation of aircraft and spacecraft. By tracking pivotal metrics such as pitch, roll, and yaw, along with any excessive or unusual vibrations, IMU circuit 402 can be advantageous in maintaining vehicle stability and performance. Any anomalies in the IMU's data can be early indicators of critical issues, thereby safeguarding against potential safety threats.

In the automotive domain, vehicles integrate IMU circuit 402 to enhance systems like electronic stability control and monitor critical components' condition, such as the alignment or suspension system. Anomalies identified by IMU circuit 402 can inform drivers or maintenance systems of underlying problems that might compromise vehicle safety or handling.

Consumer electronics, such as smartphones and tablets, leverage the IMU circuit 402 for many functionalities, including screen orientation and motion-based controls for interactive gaming. Anomalies in readings might indicate hardware issues impacting user experience or device operability.

Applications extend to civil engineering, where the IMU circuit 402 can assist structural health monitoring by being deployed on buildings or bridges. Minute swings, tilts, or vibrations detected beyond the norm can signal potential structural concerns that require further investigation to avoid hazards.

In maritime and underwater navigation, IMU circuit 402 can be used to maintain course stability and orientation. Anomalous IMU data could indicate navigational discrepancies or mechanical challenges that need urgent rectification to ensure safe passage.

The healthcare industry also utilizes the IMU circuit 402 within wearable medical devices to track patient activity levels and detect falls or instability in real time, providing crucial data for healthcare providers. Additionally, robotics and drones use IMU data to navigate complex environments reliably and maintain balance; irregular IMU signals might denote subsystem failures or environmental navigational challenges.

Further, in sports technology, equipment fitted with IMU circuit 402 can offer insights into performance while also detecting inconsistency in motion that could predict equipment failure. IMU circuit 402 in railway systems can monitor train movements to identify track irregularities or rolling stock mechanical issues, ensuring operational safety and efficiency.

Accordingly, device 404 can range across various applications, encompassing various fields and industries. Across these applications, IMU circuit 402 provides precise tracking to preemptively recognize and respond to unusual activity or conditions that might otherwise lead to faults and failures across diverse devices and structures.

For example, sensor 412 with high-g accelerometers has proven to be an effective instrument for discerning between risk-free and risky high-g motion primitives in diverse settings. These devices are notably implemented in scenarios where it is crucial to differentiate safe high-acceleration movements from those that can lead to accidents or injuries, such as in the event of a race car crash, during concussion detection in American football, or while monitoring anomalies with impact tools on construction sites.

For example, consider a vehicle crash test database based on high-g accelerometers and gyroscopes strategically placed on both crash dummies and test vehicles. These sensors can capture the critical dynamic forces exerted during crash scenarios, providing a rich source of information for analysis and an invaluable resource for enhancing safety features and preventive measures in high-risk environments.

In an exemplary case, a racecar driver routinely navigates high-g turns that, while intense, are not fatal. However, a high-g scenario resulting from a crash is both lethal and anomalous. Advantageously, the embodiment of this disclosure can differentiate and detect these scenarios effectively.

Utilizing the dataset and the methodologies disclosed herein, Principal Component Analysis (PCA) has been successfully applied to differentiate between high-g non-lethal events, such as tight turns and rapid accelerations commonly encountered on race tracks and car crash scenarios. In this particular application, it was found that the minimum distance within the cluster is a more suitable metric compared to the mean cluster distance for distinguishing between these high-intensity events.

The proposed on-sensor algorithm benefits from the capacity to detect anomalies directly on the sensor 412. This feature enables immediate response and actions without transmitting vast sensor data to the cloud or a microcontroller over a serial interface. This approach not only minimizes data transfer but also contributes to a substantial reduction in communication costs. As a result, one can design solutions characterized by exceptionally low power consumption. Additionally, the algorithm's performance is on par with traditional anomaly detection algorithms despite its lightweight nature, which parallels the simplicity of basic variance-based algorithms. This balance between efficiency and effectiveness establishes the proposed algorithm as a particularly attractive option for real-time anomaly detection in various practical applications.

Embodiments of the present disclosure can distinguish between lethal and non-lethal high-g events, leveraging advanced accelerometer technology and a specialized algorithm that considers both mean and minimum cluster distances. These embodiments are designed to intelligently select the optimal set of features from the input data without requiring manual selection or using predetermined features from accelerometer signals for the collision detection model. Further, the application of these embodiments extends beyond just car crash detection scenarios.

Uniquely, the embodiments detailed within this disclosure do not depend on data from actual collisions to train the machine-learning model. Additionally, they do not necessitate information from multiple other sensors to confirm whether a collision or anomaly has occurred. Instead, these embodiments apply rolling variance directly to the raw Inertial Measurement Unit (IMU) signal. This approach contrasts with traditional methods that calculate anomaly scores based on rolling variance applied to Principal Component Analysis (PCA) coefficients. In the present disclosure, rolling variance and PCA cluster centroid distance are independent mechanisms for determining the anomaly score.

The proposed detection logic detailed in these embodiments consists of a four-step process that applies rolling variance to the raw data and analyzes cluster centroid distances derived from PCA. This technique offers a robust solution for accurately identifying high-g events while addressing limitations in conventional systems. Further, by implementing the solution locally and without cloud-based assistance, the proposed methods provide increased user privacy.

A first aspect relates to a system for detecting anomalies. The system comprising a device and an internal measurement unit (IMU) circuit coupled to the device. The IMU circuit is configured to accumulate q samples of sensor data within a rolling window, each of the q samples of sensor data corresponding to a temporal characteristic of the device during its normal operation, calculate a rolling variance for the q samples of sensor data, extract a first principal component of the q samples of sensor data, calculate a minimum distance and a mean distance to cluster centroids based on a previously collected first principal component during a training phase, detect an anomaly within the device based on the rolling variance, the minimum distance to the cluster centroids, and the mean distance to the cluster centroids, and signal an alert signal in response to detecting the anomaly.

In a first implementation of the system according to the first aspect as such, the IMU circuit is configured to accumulate p samples of sensor data within a second rolling window, each of the p samples of sensor data corresponding to a temporal characteristic of the device during the training phase; extract the previously collected first principal component of the p samples of sensor data; and store the previously collected first principal component of the p samples of sensor data in a memory of the IMU circuit.

In a second implementation form of the system according to the first aspect as such or any preceding implementation form of the first aspect, calculating the minimum distance and the mean distance to cluster centroids based on the previously collected first principal component during the training phase comprises retrieving the previously collected first principal component from the memory.

In a third implementation form of the system according to the first aspect as such or any preceding implementation form of the first aspect, the minimum distance and the mean distance to cluster centroids are calculated in accordance with a weighted amalgamation of a Euclidean distance measurement, a fourth-order Minkowski distance measurement, and a Chebyshev distance measurement.

In a fourth implementation form of the system according to the first aspect as such or any preceding implementation form of the first aspect, a weighted factor of the Euclidean distance measurement, the fourth-order Minkowski distance measurement, and the Chebyshev distance measurement is an equal weight factor.

In a fifth implementation form of the system according to the first aspect as such or any preceding implementation form of the first aspect, the q samples of sensor data within the rolling window are accumulated within an integrated signal processing unit (ISPU) signal buffer of the IMU circuit before extracting the first principal component.

In a sixth implementation form of the system according to the first aspect as such or any preceding implementation form of the first aspect, the IMU circuit comprises an accelerometer, a gyroscope, a temperature sensor, a vibration sensor, a motion sensor, a humidity sensor, a voltage sensor, a current sensor, a pressure sensor, or a combination thereof, wherein the samples of sensor data correspond to data collected by the one or more sensors of the IMU circuit.

A second aspect relates to an internal measurement unit (IMU) circuit configured to detect anomalies in a device. The IMU circuit comprises a sensor configured to collect measurements from the device, a non-transitory memory storage comprising instructions, and an integrated signal processing unit (ISPU) coupled to the non-transitory memory storage. The instructions, when executed by the ISPU, cause the IMU circuit to accumulate, by the sensor, q samples of sensor data within a rolling window, each of the q samples of sensor data corresponding to a temporal characteristic of the device during its normal operation, calculate a rolling variance for the q samples of sensor data, extract a first principal component of the q samples of sensor data, calculate a minimum distance and a mean distance to cluster centroids based on a previously collected first principal component during a training phase, detect an anomaly within the device based on the rolling variance, the minimum distance to the cluster centroids, and the mean distance to the cluster centroids, and signal an alert signal in response to detecting the anomaly.

In a first implementation of the IMU circuit according to the second aspect as such, the instructions, when executed by the ISPU, cause the IMU circuit to accumulate p samples of sensor data within a second rolling window, each of the p samples of sensor data corresponding to a temporal characteristic of the device during the training phase; extract the previously collected first principal component of the p samples of sensor data; and store the previously collected first principal component of the p samples of sensor data in the non-transitory memory storage.

In a second implementation form of the IMU circuit according to the second aspect as such or any preceding implementation form of the second aspect, calculating the minimum distance and the mean distance to cluster centroids based on the previously collected first principal component during the training phase comprises retrieving the previously collected first principal component from the non-transitory memory storage.

In a third implementation form of the IMU circuit according to the second aspect as such or any preceding implementation form of the second aspect, the minimum distance and the mean distance to cluster centroids are calculated in accordance with a weighted amalgamation of a Euclidean distance measurement, a fourth-order Minkowski distance measurement, and a Chebyshev distance measurement.

In a fourth implementation form of the IMU circuit according to the second aspect as such or any preceding implementation form of the second aspect, a weighted factor of the Euclidean distance measurement, the fourth-order Minkowski distance measurement, and the Chebyshev distance measurement is an equal weight factor.

In a fifth implementation form of the IMU circuit according to the second aspect as such or any preceding implementation form of the second aspect, the IMU circuit further comprises an integrated signal processing unit (ISPU) signal buffer, and wherein the q samples of sensor data within the rolling window are accumulated within ISPU signal buffer before extracting the first principal component.

In a sixth implementation form of the IMU circuit according to the second aspect as such or any preceding implementation form of the second aspect, the sensor comprises an accelerometer, a gyroscope, a temperature sensor, a vibration sensor, a motion sensor, a humidity sensor, a voltage sensor, a current sensor, a pressure sensor, or a combination thereof, wherein the samples of sensor data correspond to data collected by the one or more sensors.

A third aspect relates to a method to detect anomalies in a device. The method comprising accumulating q samples of sensor data within a rolling window, each of the q samples of sensor data corresponding to a temporal characteristic of the device during its normal operation; calculating a rolling variance for the q samples of sensor data; extracting a first principal component of the q samples of sensor data; calculating a minimum distance and a mean distance to cluster centroids based on a previously collected first principal component during a training phase; detecting an anomaly within the device based on the rolling variance, the minimum distance to the cluster centroids, and the mean distance to the cluster centroids; and signaling an alert signal in response to detecting the anomaly.

In a first implementation of the method according to the third aspect as such, the method further includes accumulating p samples of sensor data within a second rolling window, each of the p samples of sensor data corresponding to a temporal characteristic of the device during the training phase; extracting the previously collected first principal component of the p samples of sensor data; and storing the previously collected first principal component of the p samples of sensor data in memory.

In a second implementation form of the method according to the third aspect as such or any preceding implementation form of the third aspect, calculating the minimum distance and the mean distance to cluster centroids based on the previously collected first principal component during the training phase comprises retrieving the previously collected first principal component from the memory.

In a third implementation form of the method according to the third aspect as such or any preceding implementation form of the third aspect, the minimum distance and the mean distance to cluster centroids are calculated in accordance with a weighted amalgamation of a Euclidean distance measurement, a fourth-order Minkowski distance measurement, and a Chebyshev distance measurement.

In a fourth implementation form of the method according to the third aspect as such or any preceding implementation form of the third aspect, a weighted factor of the Euclidean distance measurement, the fourth-order Minkowski distance measurement, and the Chebyshev distance measurement is an equal weight factor.

In a fifth implementation form of the method according to the third aspect as such or any preceding implementation form of the third aspect, the q samples of sensor data within the rolling window are accumulated within an integrated signal processing unit (ISPU) signal buffer of an Internal Measurement Unit (IMU) circuit coupled to the device before extracting the first principal component.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A system for detecting anomalies, the system comprising:
a device; and
an internal measurement unit (IMU) circuit coupled to the device, the IMU circuit configured to:
accumulate q samples of sensor data within a rolling window, each of the q samples of sensor data corresponding to a temporal characteristic of the device during its normal operation,
calculate a rolling variance for the q samples of sensor data,
extract a first principal component of the q samples of sensor data,
calculate a minimum distance and a mean distance to cluster centroids based on a previously collected first principal component during a training phase,
detect an anomaly within the device based on the rolling variance, the minimum distance to the cluster centroids, and the mean distance to the cluster centroids, and
signal an alert signal in response to detecting the anomaly.

2. The system of claim 1, wherein the IMU circuit is configured to:
accumulate p samples of sensor data within a second rolling window, each of the p samples of sensor data corresponding to a temporal characteristic of the device during the training phase;
extract the previously collected first principal component of the p samples of sensor data; and
store the previously collected first principal component of the p samples of sensor data in a memory of the IMU circuit.

3. The system of claim 2, wherein calculating the minimum distance and the mean distance to cluster centroids based on the previously collected first principal component during the training phase comprises retrieving the previously collected first principal component from the memory.

4. The system of claim 1, wherein the minimum distance and the mean distance to cluster centroids are calculated in accordance with a weighted amalgamation of a Euclidean distance measurement, a fourth-order Minkowski distance measurement, and a Chebyshev distance measurement.

5. The system of claim 4, wherein a weighted factor of the Euclidean distance measurement, the fourth-order Minkowski distance measurement, and the Chebyshev distance measurement is an equal weight factor.

6. The system of claim 1, wherein the q samples of sensor data within the rolling window are accumulated within an integrated signal processing unit (ISPU) signal buffer of the IMU circuit before extracting the first principal component.

7. The system of claim 1, wherein the IMU circuit comprises an accelerometer, a gyroscope, a temperature sensor, a vibration sensor, a motion sensor, a humidity sensor, a voltage sensor, a current sensor, a pressure sensor, or a combination thereof, wherein the samples of sensor data correspond to data collected by the one or more sensors of the IMU circuit.

8. An internal measurement unit (IMU) circuit configured to detect anomalies in a device, the IMU circuit comprising:
a sensor configured to collect measurements from the device;
a non-transitory memory storage comprising instructions; and
an integrated signal processing unit (ISPU) coupled to the non-transitory memory storage, wherein the instructions, when executed by the ISPU, cause the IMU circuit to:
accumulate, by the sensor, q samples of sensor data within a rolling window, each of the q samples of sensor data corresponding to a temporal characteristic of the device during its normal operation,
calculate a rolling variance for the q samples of sensor data,
extract a first principal component of the q samples of sensor data,
calculate a minimum distance and a mean distance to cluster centroids based on a previously collected first principal component during a training phase,
detect an anomaly within the device based on the rolling variance, the minimum distance to the cluster centroids, and the mean distance to the cluster centroids, and
signal an alert signal in response to detecting the anomaly.

9. The IMU circuit of claim 8, wherein the instructions, when executed by the ISPU, cause the IMU circuit to:
accumulate p samples of sensor data within a second rolling window, each of the p samples of sensor data corresponding to a temporal characteristic of the device during the training phase;
extract the previously collected first principal component of the p samples of sensor data; and
store the previously collected first principal component of the p samples of sensor data in the non-transitory memory storage.

10. The IMU circuit of claim 8, wherein calculating the minimum distance and the mean distance to cluster centroids based on the previously collected first principal component during the training phase comprises retrieving the previously collected first principal component from the non-transitory memory storage.

11. The IMU circuit of claim 8, wherein the minimum distance and the mean distance to cluster centroids are calculated in accordance with a weighted amalgamation of a Euclidean distance measurement, a fourth-order Minkowski distance measurement, and a Chebyshev distance measurement.

12. The IMU circuit of claim 11, wherein a weighted factor of the Euclidean distance measurement, the fourth-order Minkowski distance measurement, and the Chebyshev distance measurement is an equal weight factor.

13. The IMU circuit of claim 8, wherein the IMU circuit further comprises an integrated signal processing unit (ISPU) signal buffer, and wherein the q samples of sensor data within the rolling window are accumulated within ISPU signal buffer before extracting the first principal component.

14. The IMU circuit of claim 8, wherein the sensor comprises an accelerometer, a gyroscope, a temperature sensor, a vibration sensor, a motion sensor, a humidity sensor, a voltage sensor, a current sensor, a pressure sensor, or a combination thereof, wherein the samples of sensor data correspond to data collected by the one or more sensors.

15. A method to detect anomalies in a device, the method comprising:
accumulating q samples of sensor data within a rolling window, each of the q samples of sensor data corresponding to a temporal characteristic of the device during its normal operation;
calculating a rolling variance for the q samples of sensor data;
extracting a first principal component of the q samples of sensor data;
calculating a minimum distance and a mean distance to cluster centroids based on a previously collected first principal component during a training phase;
detecting an anomaly within the device based on the rolling variance, the minimum distance to the cluster centroids, and the mean distance to the cluster centroids; and
signaling an alert signal in response to detecting the anomaly.

16. The method of claim 15, further comprising:
accumulating p samples of sensor data within a second rolling window, each of the p samples of sensor data corresponding to a temporal characteristic of the device during the training phase;
extracting the previously collected first principal component of the p samples of sensor data; and
storing the previously collected first principal component of the p samples of sensor data in memory.

17. The method of claim 16, wherein calculating the minimum distance and the mean distance to cluster centroids based on the previously collected first principal component during the training phase comprises retrieving the previously collected first principal component from the memory.

18. The method of claim 15, wherein the minimum distance and the mean distance to cluster centroids are calculated in accordance with a weighted amalgamation of a Euclidean distance measurement, a fourth-order Minkowski distance measurement, and a Chebyshev distance measurement.

19. The method of claim 18, wherein a weighted factor of the Euclidean distance measurement, the fourth-order Minkowski distance measurement, and the Chebyshev distance measurement is an equal weight factor.

20. The method of claim 15, wherein the q samples of sensor data within the rolling window are accumulated within an integrated signal processing unit (ISPU) signal buffer of an Internal Measurement Unit (IMU) circuit coupled to the device before extracting the first principal component.
